(19) United States
(12) Patent Application Publication
(10) Pub. No.: US 2012/0143952 A1
(43) Pub. Date: Jun. 7, 2012

(54) SYSTEM AND METHOD FOR EVENT FRAMEWORK

(76) Inventor: Fred von Graf, Mesa, AZ (US)

(21) Appl. No.: 13/309,538

(22) Filed: Dec. 1, 2011

Related U.S. Application Data
(60) Provisional application No. 61/458,781, filed on Dec. 1, 2010.

(51) Int. Cl. G06F 15/16

(52) U.S. Cl. 709/204

(57) ABSTRACT

The framework provides a way to create and organize “tasks” or “activities” into “events” with disparate configurations that can be used to model everything from games to relationships to business processes. Each event will have one or more tasks that will require certain steps or actions in order to be completed. Once all required activities or tasks in a given event have been completed, the goals and objectives associated with that event will have been accomplished. It is possible to provide various rewards or incentives as various tasks or combinations of tasks are completed. The framework provides a way to quickly and easily create multiple events, specifically targeted to very narrow needs and circumstances, providing significantly greater flexibility for the use of social networking tools and services in many more environments.

### RELATED APPLICATION

This patent application claims priority under 35 U.S.C. §119 (e) to the filing date of U.S. Provisional Patent Application Ser. No. 61/458,781, which application was filed on Dec. 1, 2010 and the disclosure of which is incorporated herein by reference.

### BACKGROUND OF THE INVENTION

1. Technical Field

The present invention relates generally to the field of computer-based activity and more specifically relates to a system and method for creating computer and mobile device based activities.

2. Background Art

The generation and completion of tasks and events is common to all societies and people. Whether for business, pleasure, or other reasons, the ability to create and define tasks and activities consumes much of our lives. Some events are enjoyable and entertaining while others are boring and mundane. As generally social creatures, mankind is known to band or flock together to accomplish shared objectives in families, gangs, businesses, etc.

A relatively recent development in the human experience is the rapid rise of digital “social networking” and “social media.” Social networks refer generally to the gathering and grouping together of individuals for social reasons. While social networking has been around as long a humans have been in existence, the use of electronic social media tools has allowed people to interact with other individuals and entities via the Internet and other electronic communication mediums. The term “social media” generally refers to the use of web-based and mobile technologies to turn communication into an interactive dialogue. Social media also includes electronic media for social interaction, as a superset beyond traditional social communication. Enabled by almost ubiquitously accessible and scalable communication techniques, social media substantially change the way of communication between organizations, communities, as well as individuals.

Modern social networking, using social media, is steadily becoming a major part of every day life in many countries. The use of social networking tools and services such as Facebook®, Twitter®, FourSquare®, LinkedIn® and other similar services are becoming widespread. Businesses, schools, municipalities, government agencies, and even individuals are rapidly integrating social networks and related activities into virtually every aspect of their daily routines. For example, businesses are constantly looking for ways to apply social networking tools and activities to market their products and services to their customers and prospects in new and innovative ways. Individuals are using various social networking media to meet and make new friends, as well as to stay connected with both families and friends.

While the utility of leverage social networking tools is rapidly increasing, there are still many areas where social networking has yet to be successfully adopted. One such area is the use of social media and tools for task creation and completion in a business or other professional environment. For example, many organizations are not willing to accept widespread adoption of social networking tools and related media channels because many social networking tools are directed towards activities and events that are not conducive to an efficient and productive work environment. In these situations, social networking and social media may be viewed as an unwanted distraction or even worse. Similarly, although the use of social media is widespread amongst individuals, the tools are relatively cumbersome to adapt and many individuals find the existing social media tools lacking in one respect or another. However, since creating new social media tools is not a simple undertaking, flexibility and customization remain challenging for most users.

Additionally, given the often specialized needs for customized applications of social networking tools, many organizations and individuals find that the existing social networking tools and services are not readily adaptable to their specific circumstances. Since the creation of functional and highly targeted social networking tools can be quite expensive, many individuals and organizations have simply made a decision to forgo their use. Accordingly, without improvements in the current systems, methods, and tools for creating additional meaningful social networking tasks and activities, the overall widespread adoption and implementation of social networking tools into certain areas of society, including task and event creation and completion, will continue to be sub-optimal.

### BRIEF SUMMARY OF THE INVENTION

The various preferred embodiments of the present invention provides a framework and a series of tools to rapidly and effectively create and deploy user-created, customizable models for activities and events. The framework provides a way to create and organize “tasks” or “activities” into“events” with disparate configurations that can be used to model everything from games to relationships to business processes. Each event will have one or more tasks that will require certain steps or actions in order to be completed. Once all required activities or tasks in a given event have been completed, the goals and objectives associated with that event will have been accomplished. It is possible to provide various rewards or incentives as various tasks or combinations of tasks are completed. Additionally, the framework provides a comprehensive set of tools to monitor and report on the behavior of the participants in a designated event. The framework provides a way to quickly and easily create multiple events, specifically targeted to very narrow needs and circumstances, providing significantly greater flexibility for the use of social networking tools and services in many more environments.

### BRIEF DESCRIPTION OF THE FIGURES

The various preferred embodiments of the present invention will hereinafter be described in conjunction with the appended drawings, wherein like designations denote like elements, and:

FIG. 1 is a perspective view of a computer and mobile device based system for providing an activity framework in accordance with a preferred exemplary embodiment of the present invention;

FIG. 2 is a block diagram of a server used for implementing an activity framework in accordance with a preferred exemplary embodiment of the present invention;

FIG. 3 is a block diagram illustrating the interaction of a user interface and the creation of events and tasks in accordance with a preferred exemplary embodiment of the present invention;

FIG. 4 is a flow chart of a method for creating, launching and monitoring an event in accordance with a preferred exemplary embodiment of the present invention;

FIG. 5 is a schematic view of various graphical representations of the tasks in an event generated by a event framework in accordance with a preferred exemplary embodiment of the present invention.

### DETAILED DESCRIPTION OF THE INVENTION

The various preferred embodiments of the present invention provides a framework and a series of tools to rapidly and effectively create and deploy user-created, customizable models for activities and events. The framework provides a way to create and organize “tasks” or “activities” into“events” with disparate configurations that can be used to model everything from games to relationships to business processes. Each event will have one or more tasks that will require certain steps or actions in order to be completed. Once all required activities or tasks in a given event have been completed, the goals and objectives associated with that event will have been accomplished. It is possible to provide various rewards or incentives as various tasks or combinations of tasks are completed. Additionally, the framework provides a comprehensive set of tools to monitor and report on the behavior of the participants in a designated event. The framework provides a way to quickly and easily create multiple events, specifically targeted to very narrow needs and circumstances, providing significantly greater flexibility for the use of social networking tools and services in many more environments. For purposes of this application, “event” can be defined as any collection of tasks or activities that have been grouped together for completion by one or more participants in the event. Accordingly, event could mean a game, a training seminar, a tour, a training or educational program, or any combination of similar events.

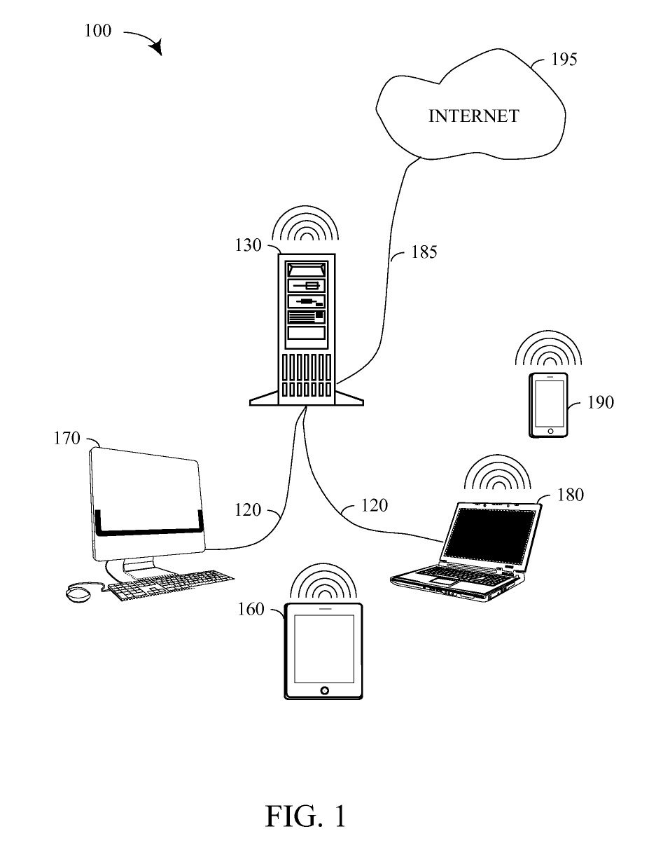

Referring now to FIG. 1, a system 100 for providing an event framework in accordance with a preferred exemplary embodiment of the present invention comprises: a data server 130; at least one of a desktop computer 170, a laptop computer 180, a tablet 160, and a phone or Personal Digital Assistant (“PDA”) 190 all connected or coupled via a network or networks 120 to the Internet 195 via an Internet connection 185.

Taken together, the components of system 100 provide a platform and framework for designing, creating, and monitoring a plurality of event-based tasks and/or activities, and also provide a facility for related event tracking and event participant messaging and communication services. In some embodiments, data server 130 receives information about tasks and events directly from computer 170, laptop computer 180, tablet 160 or phone 190; in other embodiments, data server 130 receives information about events from a separate database, which may reside on a different data server (not shown this FIG.).

Data may be transferred from a separate database by any means including text file transfers, connection over network 120 to the database itself, connection to a third party, or any means known to those skilled in the art, whether currently known or developed in the future. System 100 provides a mechanism for a group of users to efficiently and effectively create, track, store, monitor, and report the occurrence of various activity related events and the results of events as well as make decisions and take actions based upon the occurrence of the events.

In the most preferred embodiments of the present invention, system 100 is configured as a system that will be used to track and monitor certain aspects of participant behavior and performance, including participation in the pre-determined event activities. In this embodiment, the group of users for system 100 will typically include event creation users and participants, where the event creators and event participants may overlap to one degree or another. Further, depending on the specific preferences of the designers that created the event, limited access to various features and functions of system 100 may be provided to certain classes of event participants and for certain events.

Network 120 represents any suitable computer communication link or similar communication mechanism, including some combination of a hardwired connection, an internal or external bus, a connection for phone access via a modem, a standard co-axial cable line, a high-speed T1 line, radio, infrared or other wireless communication methodologies (i.e. Bluetooth®, infrared (IR) links, etc.), private or proprietary local area networks (LANs) and wide area networks (WANs), as well as standard computer network communications over Internet 195 or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, a broadcast cable transmission line, a Digital Subscriber Line (DSL), an ISDN line, or similar public utility-like access link.

In the most preferred embodiments of the present invention, at least a portion of network 120 comprises a standard wired or wireless Internet connection 185 between the various components of system 100 for providing access to additional network resources and other remote locations. Network 120 provides for communication between the various components of system 100 and allows for relevant information to be transmitted from device to device. In this fashion, a user of system 100, including event designers and event participants, can quickly and easily gain access to the relevant event-related data and associated information to search, retrieve, and display information from one or more databases as described in conjunction with the preferred embodiments of the present invention.

In the most preferred embodiments of the present invention, network 120 is configured to provide relatively high-speed transmission of both audio and video data and signals and comprises at least a wired or wireless Internet connection 185 for transmission of data captured by one or more computers 170 or 180 and a phone connection for transmission of an audio signal to and from phone 190. The phone connection may be interfaced to a standard phone system typically found in most homes and commercial facilities, including for example, the existing “land line” phone system infrastructure and/or digital cellular phone communication systems.

In addition to the other components shown in FIG. 1, a wireless communication access device may be communicatively coupled to network 120 and may be any wireless communication mechanism that is known to those skilled in the art to provide for wireless communication between network 120 and the various devices associated with network 120, including desktop computer 170, laptop computer 180, tablet 160, and phone 190. The most preferred embodiments of an acceptable wireless communication access device may comprise any type of wireless bridge, wireless router, or similar type of device (not shown this FIG.).

Regardless of the specific components, physical nature, and topology, network 120 serves to logically and communicatively link the physical components of system 100, thereby enabling stable and consistent communication between the components. This is especially important because in many preferred embodiments of the present invention, data server 130, desktop computer 170, and laptop computer 180 may be geographically remote and/or physically separated from each other. Further, since many activities may include events at disparate geographical locations, communications using mobile devices such as tablet 160 and/or phone 190.

Data server 130 represents a relatively powerful computer system that is made available to desktop computer 170, laptop computer 180, tablet 160 and/or phone 190 via network 120. Each of these components (desktop computer 170, laptop computer 180, tablet 160 and/or phone 190) can send information to data server 130 or receive information from data server 130. Not shown in FIG. 1 are other components that may be connected to data server 130 via network 120, including other components that may both send and receive data, and components that can only receive information from data server 130, such as printers and facsimile machines. Various hardware components (not shown this FIG.) such as external monitors, keyboards, mice, tablets, hard disk drives, recordable CD-ROM/DVD drives, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art.

Given the relative advances in the state-of-the-art computer systems available today, it is anticipated that functions of data server 130 may be provided by many standard, readily available data servers. This may also include the deployment of multiple inter-connected and/or redundant data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for identifying users and controlling access as well as creating and verifying digital signatures (i.e., electronic signature processing) may also be included.

Desktop computer 170 may be any type of computer system known to those skilled in the art that is capable of being configured for use with system 100 as described herein. It should be noted that no specific operating system or hardware platform is excluded and it is anticipated that many different hardware and software platforms may be configured to create computer 170. As previously explained in conjunction with data server 130, various hardware components and software components (not shown this FIG.) known to those skilled in the art may be used in conjunction with computer 170. It should be noted that in the most preferred embodiments of the present invention, desktop computer 170 is linked (via wired or wireless connection) to its own LAN, a WAN, or Internet 195 and has access to one or more additional data servers (not shown this FIG.).

In addition as shown in FIG. 1, a tablet 160 may be used in conjunction with computer 170 and/or data server 130 to allow audio and/or video messages and alerts to be communicated to various devices. Tablet 160 may be any type of tablet or slate computer and includes any of the commercially available tablet computers known to those skilled in the art (e.g., iPad®, TouchPad®, etc.). In this application, tablet 160 has been communicatively coupled to or otherwise interfaced and associated with one or more users of system 100. Similarly, audio, video, and text messages and alerts may be communicated to or from phone 190. Using tablet 160, event designers and event participants may interact with system 100 and other users to create, monitor, and participate in event-related events.

Additionally, laptop computer 180 may be any type of relatively lightweight portable computer system known to those skilled in the art that is capable of being configured for use with system 100 as described herein, including netbook computers and the like. Computer 180 may also be configured to send and/or receive audio, video and text signals, messages, and alerts via server 130 and network 120. Each of desktop computer 170 and laptop computer 180 may also be consider a user workstation for accessing and manipulating the data stored and processed in conjunction with server 130.

Additionally, netbooks, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN, a WAN, or Internet 195 and has access to its own data server (not shown this FIG.).

In general, the communication between devices associated with data server 130 will be data associated with tracking, monitoring and reporting information regarding certain activities and their associated events. The users of desktop computer 170 and/or laptop computer 180 may be program administrators, managers, teachers, students, etc. who are involved in the creation, monitoring or participating in events.

It should be noted that while FIG. 1 shows only a single desktop computer 170 and a single laptop computer 180, it is anticipated that the most preferred embodiments of the present invention will comprise dozens or even hundreds or millions of computers 170 and laptop computers 180, with various users accessing system 100 via these user workstations. Each of these computers 170 and 180 will be configured to access data server 130 in an appropriately secure way so as to accomplish the specific objectives of the user of the desktop computer 170 or laptop computer 180.

For example, the service provider that controls the databases stored on data server 130 may utilize desktop computer 170 or laptop computer 180 as user workstations to access data server 130 and create, update or otherwise modify a given database to create or modify an event and the associated tasks or activities. An operator, located in a remote location, may use desktop computer 170 or laptop computer 180 to access data server 130 to retrieve information about the persons and events being monitored or tracked by the users of system 100.

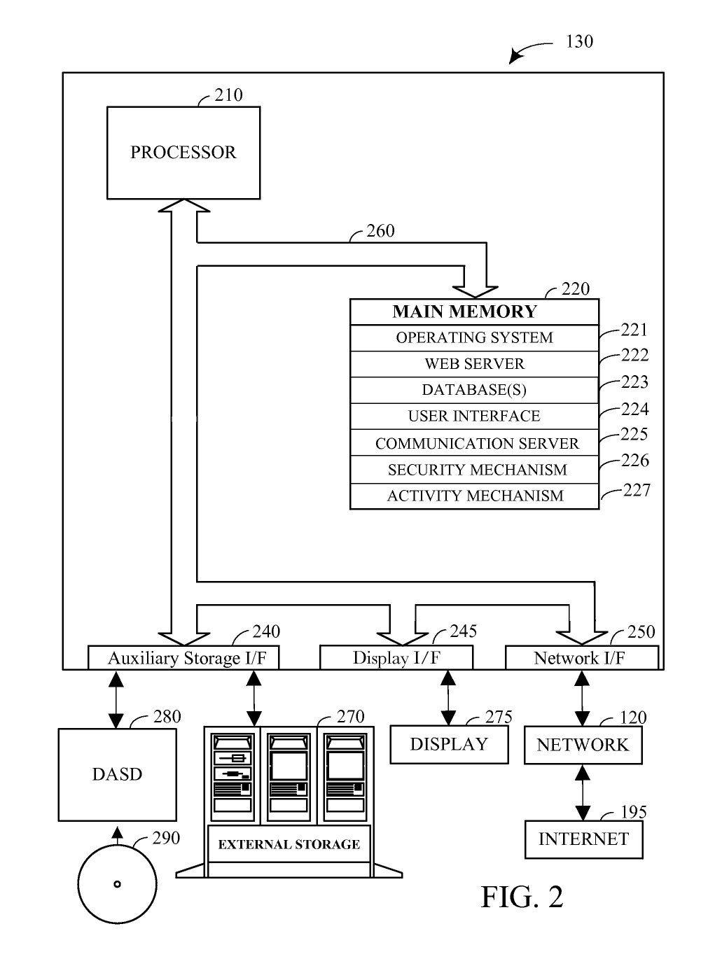

In the most preferred embodiments of the present invention, multiple desktop computers 170 and multiple laptop computers 180 will all be configured to communicate simultaneously with data server 130 and with each other via network 120. In addition, the most preferred embodiments of the present invention include an Application Service Provider (ASP) or Software as a Service (“SAAS”) environment where data server 130 may be operated in a hosted environment. In this fashion, multiple desktop computers 170 and laptop computers 180 will have access to data server 130 and the databases stored thereon via a global computer network such as Internet 195. Data server 130 is further described below in conjunction with FIG. 2 below.

An optional printer and an optional fax machine (not shown this FIG.) may also be deployed for various hard copy data output requirements and may be considered to be any standard peripheral devices used for transmitting or outputting paper-based documents, notes, transaction details, reports, etc. in conjunction with the various requests and transactions processed by system 100 (e.g., reports, statistical analyses, automated letters, etc.) Finally, it should be noted that the optional printer and the optional fax machine are merely representative of the many types of peripherals that may be utilized in conjunction with system 100. It is anticipated that other similar peripheral devices will be deployed in the various preferred embodiment of the present invention and no such device is excluded by its omission in FIG. 1.

Phone 190 is representative of any type of cellular device or phone that may be communicatively coupled to system 100. This includes, for example, personal digital assistants (“PDAs”), Windows® mobile phone devices, Palm® OS devices, Pocket PC® devices, the Droid® smartphones, the iPhone® and other various types of phones. Those skilled in the art will recognize these various devices and others that are suitable for deployment as phone 190. While somewhat less powerful than computers 170 and 180, phone 190 may also be configured to wirelessly communicate with data server 130 via network 120 to send and retrieve event and activity related information to and from data server 130. Using phone 190, event designers and event participants may interact with system 100 and other users to create, monitor, and participate in event-related tasks and activities. In the most preferred embodiments of the present invention, each phone 190 will be configured with a mobile application or “app” that provides a user interface that allows the person using phone 190 to access and interface with the other components of system 100, including communications with other event creators and event participants.

Given the standard functionality for devices that may be deployed as phone 190, this communication be provided by a wireless Internet connection 185 (e.g. “wi-fi” or “wi-max”) or a Bluetooth® connection. One example of the use for phone 190 in the context of system 100 would be to automatically track the location of an event participant and to send messages or alerts relative to the participant's location, alerting other event participants of the location of the event participant using GPS or other location determination means.

Those skilled in the art will recognize that FIG. 1 depicts a fairly standard “client/server” type communication arrangement where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that must be transferred from a database to the user of system 100. In some preferred embodiments of the present invention, this minimization is accomplished as data server 130 receives and aggregates information about activities and events directly from desktop computer 170, laptop computer 180, tablet 160 or phone 190.

Referring now to FIG. 2, data server 130 of FIG. 1 in accordance with a preferred embodiment of the present invention represents one of many commercially available computer systems such as a Linux®-based computer system, an IBM® compatible computer system, or a Macintosh® computer system. However, those skilled in the art will appreciate that the methods and system of the present invention apply equally to any computer system, regardless of the specific operating system and regardless of whether the computer system is a more traditional “mainframe” computer, a complicated multi-user computing device or a single user device such as a personal computer or workstation.

Data server 130 suitably comprises at least one Central Processing Unit (CPU) or processor 210, an auxiliary storage interface 240, a display interface 245, and a network interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 is configured to execute one or more software programs contained within main memory 220. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disc 290.

Display interface 245 is used to directly connect one or more displays 275 to data server 130. Display 275, which may be non-intelligent (e.g., “dumb”) terminals or fully programmable workstations, are used to provide system administrators and users the ability to communicate with data server 130. Note, however, that while display interface 245 is provided to support communication with one or more displays 275, computer data server 130 does not necessarily require a display 275, because all needed interaction with users and other processes may occur via network 120. Additionally, in certain preferred embodiments, data server 130 may have an integrated display 275.

Network interface 250 is used to connect data server 130 to network 120 and system 100, including computer 170 and computer 180 of FIG. 1. Network interface 250 broadly represents any suitable way to interconnect electronic devices, regardless of whether network 120 comprises present day analog and/or digital techniques or some networking mechanism of the future. Network interface 250 preferably includes a combination of hardware and software that allows communications on network 120.

Software provided in conjunction with network interface 250 preferably includes a communication manager that manages communication with other computer systems or other network devices via network 120 using a suitable network protocol. Many different network protocols can be used to implement network 120. These protocols are specialized computer programs that allow computers to communicate across a network 120. TCP/IP (Transmission Control Protocol/Internet Protocol) is just one example of a suitable network protocol that may be used by the communication manager contained within network interface 250.

It is important to note that while the present invention has been (and will continue to be) described in the context of a fully functional computer system with certain application software, those skilled in the art will appreciate that the various software mechanisms of the present invention are capable of being distributed as a program product in conjunction with an article of manufacture comprising a software application stored on a computer readable storage medium in a variety of forms, and that the various preferred embodiments of the present invention applies equally regardless of the particular type or storage medium used to actually carry out the distribution. Examples of computer readable storage media include: recordable type media such as DVD and CD-ROM discs (e.g., disc 290), and transmission type media such as digital and analog communication links, including wireless communication links.

Main memory 220 suitably contains an operating system 221, a web server 222, one or more databases 223, a user interface 224, a communication server 225, a security mechanism 226, and an event mechanism 227. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual software mechanisms or components shown in main memory 220 might be combined in various forms and distributed as a stand-alone program product. Finally, it should be noted that additional software components, not shown in this figure, might also be included.

Operating system 221 includes the software that is used to operate and control data server 130. In general, processor 210 typically executes operating system 221. Operating system 221 may be a single program or, alternatively, a collection of multiple programs that act in concert to perform the functions of operating system 221. Any operating system now known to those skilled in the art or later developed may be considered for inclusion with the various preferred embodiments of the present invention.

Web server 222 may be any web server application currently known or later developed for communicating with web clients over a network such as Internet 195. Examples of suitable web servers 222 include Apache® web servers, IIS web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, web server 222 provides access, including a user interface, to allow individuals and entities to interact with user interface 224, including via network 120 of FIG. 1.

Databases 223 is representative of any suitable database or databases known to those skilled in the art. Database 223 may store records of (i.e. relating to) tasks, activities, events and individuals, including user names, passwords, profiles, etc. As used herein, “individual” and “individuals” may also refer to entities, such as people or corporations, which are recorded in the database. Additionally, information regarding activities and events will be stored in database 223 and made available to the event creators and event participants in conjunction with the use of system 100 of FIG. 1.

In most preferred embodiments of the present invention, database 223 stores information about individuals such as user name, password, contact information, user preferences, social affiliations, social networking and social media accounts, addresses, photographs, etc. and it also stores information about activities and events relating to the individuals, including the progress of the individuals in completing tasks and events. In the most preferred embodiments of the present invention, database 223 is a Structured Query Language (SQL) compatible database file capable of storing information relative to various items that may be of interest to the users of system 100 of FIG. 1. In the most preferred embodiments of the present invention, database 223 will comprise a plurality of information that may be useful to an organization or individual that wants to perform event and task tracking and reporting activities in conjunction with a preferred embodiment of system 100 of FIG. 1.

User interface 224 is a software component that provides the users of system 100 of FIG. 1 a means for interacting with the various components of system 100. In the most preferred embodiments of the present invention, user interface 224 includes a web browser based graphical user interface, accessible to the users of system 100 via any standard web browser from any computer that is connected to Internet 195 of FIG. 1. Users can interact with user interface 224 to create and modify account information as well as interact with activity mechanism 227 to update their status and the completion for various tasks that are associated with an event.

User interface 224 allows users of system 100 to transmit data, such as messages, alerts, responses, and/or commands, to components of system 100 and/or to receive data (such as messages and/or charts) from components of system 100. Accordingly, in some embodiments user interface 224 may include phone based interfaces, phone “mobile app” interfaces, email interfaces, and/or interfaces that only receive data such as printer or facsimile based interfaces. Those skilled in the art will understand that many variations of user interface 224 are possible. Additional details on user interface 224 are presented below.

In at least one preferred embodiment of the present invention adapted for creating, monitoring and participating in event based activities, database 223 will typically include a plurality of database records containing information about the individuals participation in specific events and tasks created by the methods and tools of the present invention. This includes locations, times, dates, scores, task completion percentages, and other information providing for tracking, analyzing and reporting user participation and performance that may be used to provide various data to the users of system 100 of FIG. 1.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 may also be physically stored in a location other than main memory 220. For example, database 223 may be stored on external storage device 270 or DASD 280 and coupled to data server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented.

The most preferred embodiments of system 100 of FIG. 1 will typically include a communication server 225 in main memory 220. Communication server 225 is an automated programmable system that is capable of generating one or more forms of messages or message events. For example, communication server 225 may be configured to send automated email messages or SMS messages to cell phones. Communication server 225 may also be used to generate hard copy messages (e.g., mail merge letters) that are then sent via standard U.S. Postal Service or some type of commercial message delivery company. In the most preferred embodiments of the present invention communication server 225 will be used to send and receive updates and message related to events and the completion of tasks associated with events. This includes integration with social media such as LinkedIn®, Facebook®, MySpace®, Twitter®, Foursquare®, etc. so as to provide user-configurable automatic messaging services regarding an event participants progress during events to those social media connections. In the most preferred embodiments of the present invention, an application programming interface (“API”) is included to allow for rapid and efficient integration of the event framework with other programs and environments.

Additionally, communication server 225 may be configured to generate a facsimile message by utilizing a fax server and a facsimile modem (not shown this FIG.) that is contained in data server 130 of FIG. 2. Communication server 225 is also capable of being configured and used to send and receive various electronic status messages (e.g. audio and video alerts) and updates to data server 130 and between computers 170, 180, and/or phone 190 of FIG. 1, as may be necessary to enhance the overall process of completing tasks and activities related to the provision of event tracking and reporting services as described herein.

This also includes the generation of on-demand and automated email messages relating to the tracking and reporting of performance and events as well as sending informational messages related to event participants, etc. Automated or on-demand e-mail messages are also generated to provide event related notifications (e.g., messages and other data related to and regarding the status of task completion) as well as other information related to the events and event participants in accordance with the various preferred embodiments of the present invention.

In addition, most preferred embodiments of the present invention will include a security and/or encryption mechanism 226 for verifying access to the data and information contained in and transmitted to and from data server 130. Security mechanism 226 may be incorporated into operating system 221 and/or web server 222. Additionally, security mechanism 226 may also provide encryption capabilities for other components of system 100 of FIG. 1, thereby enhancing the robustness of system 100 of FIG. 1. Security mechanism 226 is most preferably configured to protect the integrity and security of the information transmitted via network 120 of FIG. 1. In most preferred embodiments security mechanism 226 defines permissions for users, which limit what each user can do based on that user's role (e.g. event creator, task creator, event participant, etc.).

Further, depending on the type and quantity of information stored in database 223 and accessed by user interface 224, security mechanism 226 may provide different levels of security and/or encryption for different computer systems 170 and 180 of FIG. 1 and the information stored in database 223. The level and type of security measures applied by security mechanism 226 may be determined by the identity of the end-user and/or the nature of a given request and/or response. In some preferred embodiments of the present invention, security mechanism 226 may be contained in or implemented in conjunction with certain hardware components (not shown this FIG.) such as hardware-based firewalls, switches, dongles, and the like.

Activity mechanism 227 is the heart of the event framework described herein. It is a software mechanism that controls and interacts with the other components to allow a user to create, modify, implement, and monitor events. User interface 224 provides a graphical interface to activity mechanism 227, allowing the event creator to add, modify and delete tasks to one or more events. In addition, user interface 224 and activity mechanism 227 provide the user with a simple way to add, delete, and modify the data stored in databases 223, as well as create and produce reports on the events and associated activities generated by event participants.

For example, as event participants complete tasks, the authentication of the completion, as well as the identity and other information related to the completion of a task by an event participant is stored in database 223 by activity mechanism 227. This data can be parsed and examined to determine trends and to report past behavior and model future behavior.

In the most preferred embodiments of the present invention, the various components of system 100 of FIG. 1 are able to communicate using multiple communications protocols and systems (e.g., Voice over IP or “VoIP”, Plain Old Phone Service or “POTS”, etc.). Those skilled in the art will recognize that the communication protocols used herein may be readily adapted and configured to allow for the rapid and efficient transmission and receipt of data by and between the various components of system 100 of FIG. 1. This would also include the ability to control and customize the input and output of system 100 of FIG. 1 for integration with other systems. While a specific exemplary embodiment of a suitable server 130 has been provided above, those skilled in the art will recognize that many other suitable computers (with more or fewer features) may be substituted for the specific example provided herein without departing from the spirit and scope of the present invention.

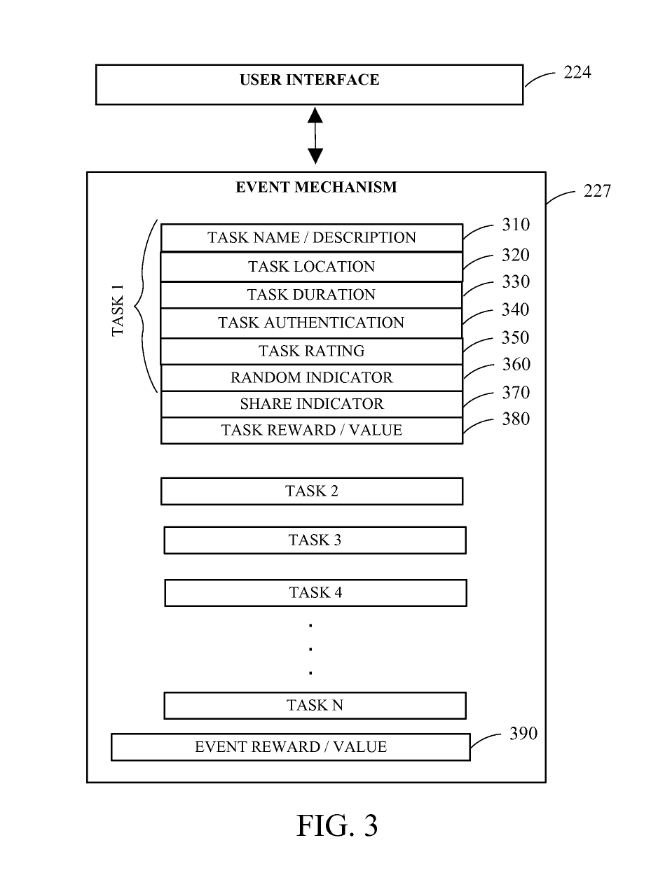

Referring now to FIG. 3, a block diagram for the creation of an event using event mechanism 227 is presented. As shown in FIG. 3, user interface 224 provides a way for the users of system 100 of FIG. 1 to interact with event mechanism 227. In the most preferred embodiments of the present invention, event mechanism 227 allows users to create one or more activities, with each event comprising one or more tasks, and with each task comprising a plurality of task attributes. As shown in FIG. 3, an event can be created from one or more tasks, and the number of tasks that may be included in a given event is unlimited.

Each task or activity in a given event may be created and defined by the following non-limiting examples: a task name and/or description 310; a task location 320; a task duration 330; a task authentication protocol 340; a task rating 350; a random indicator 360; a share indicator 370; and a task reward or task value 380. Those skilled in the art will recognize that the event attributes described herein are non-limiting and non-exhaustive but merely representative. More or fewer task attributes may be included by an event organizer and not all task attributes may be present in all tasks for each activity created via event mechanism 227. Various preferred embodiments of the present invention and various applications may use different task attributes, as necessary or desired.

A task name and/or description 310 is used to name and describe each task for a given event. The name and description can be used to quickly and easily identify each task in an event. This is also important since individual tasks may be re-used and re-combined in multiple events. A user can create a “pool” of predefined tasks and then quickly and easily create new events by simply combining and configuring various previously created tasks for the desired event. Additionally, depending on the status of the share indicator 370 for a given task, it is also possible to allow users of system 100 of FIG. 1 to create events using tasks that have been previously created by other users of system 100 of FIG. 1. Task description 310 may also include the identities or profile of the anticipated and/or approved event participants. For example, participation in an event may be limited to a pre-determined group of participants, open to all, or to a limited number of participants based on geographic location, demographic profile, or “first come first served” basis.

Task location 320 is an event attribute that can be used to describe and configure the location where the associated task is to take place. The event location may be configured by the event creator to be a physical or virtual location. Unlike other previously created systems, task location 320 may be a physical geographic location (e.g., park, store, business, etc.) or a virtual location (e.g., uniform resource locator or “URL” or webpage, certain page within a book, certain scene within a movie, etc.) that is independent of any physical location and that may be “visited” by the event participant without regard to the actual physical location of the event participant. Further, each task location may also include a time descriptor, indicating not only a specific location, but a time frame that is also associated with the location for the task. Accordingly, it is possible to include tasks that must occur at a specific location and within a pre-determined time frame as well. This provides additional flexibility for the creation of the tasks that will be used to define an events.

Task duration 330 is an event attribute that can be used to describe the amount of time or the duration associate with a given task. This will allow the creator of the event to “time out” a task after a pre-determined period of time. This may represent a single point in time (e.g., 10:00 pm) or a measured amount of time (e.g., 30 minutes are arriving at the designated task location).

Task authentication 340 is an task attribute that can be used to describe the method of authentication to verify completion of a task during the course of an event. This allows the creator of an event to ensure that the event participant has actually completed the specific event. There are a number of authentication protocols available for use by the event creator. For example, there may be a “gentlemen's agreement” authentication whereby the creator of the event allows the event participant to simply respond that they have completed the event and the event creator accepts that response as the authentication needed to verify completion of the event. Alternatively, the authentication may require the input of another event participant, or designated “referree” or “umpire” to gain authentication that the event has been completed. This will allow the event creator to encourage or require cooperation, or not, as desired for a given event.

Other authentication protocols may simply capture the activity participant's physical location by means of a automatically generated location signal (e.g., cell phone GPS coordinates) or location specific wi-fi signal. It is also possible to require the event participant to capture a specific photo at the given location, or to use a graphical “tag” such as a Quick Response (“QR”) code or Microsoft® glyph tag with a cell phone camera. These are only examples of the types of authentication protocols that may be incorporated into an event for a task and each task may require one or more unique task authentications 340. Upon authentication, it is also possible to report the task completion back to server 130 of FIG. 2 for updating one or more of the associated databases. Additionally, by integrating with various social media tools, the status of task and/or event completion can be posted to the event participant's social media sites and services, allowing others to track the progress of the event participant as the event participant completes the tasks associated with the event. In certain preferred embodiments of the present invention, the task creator may decide to include multiple task authentications 340.

Once a given task has been authenticated, the authentication can be transmitted back to one or more of the databases shown in FIG. 2, thereby allowing for the monitoring and reporting of the event in real time, if desired. Alternatively, it may be desired to “batch” and update task activity based on a criteria other than time of completion or authentication. This is a significant difference that illustrates another unique aspect of the present invention. Many social networking tools allow a participant to “check into” a geographical location upon arrival. While useful, approach has certain drawbacks. For example, by announcing where you are, you are simultaneously announcing where you are not. This could introduce certain vulnerabilities for come people. If a stalker is following your location via social media, you may not want to announce your location via social media. If your are away from your residence, you may not wish to announce that you are not at your residence since your residence may be deemed at risk since some unscrupulous individuals may use the announcement as a signal that your residence is safe to invade.

Accordingly, for the various preferred embodiments of the present invention, it is possible to specify a reporting criteria associated with task completion and task authentication 340. For example, as an event participant completes a task, the results of task authentication 340 may be stored for a pre-determined period of time prior to being reported to any social media outlet. Then, once the pre-determined period of time has elapsed, the task completion and authentication can be reported. Alternatively, it may be desirable to use “geo fencing” to determine when to report and/or announce task completion and authentication. In this fashion, the results of task authentication can be stored and reported once the event participant reaches or leaves a certain geographical location.

Task rating 350 is an task attribute that can be used to describe the rating associated with a given task. For example, the task creator can choose to assign a rating to a task that would allow others, including event participants and other event creators that might use the task in their own events, to quickly grasp the nature of the task. Task rating 350 may be in indicator of task difficulty (e.g., “easy,” “medium,” or “hard” difficulty) or an indicator of task enjoyment (e.g., “dull,” “boring,” “engaging,” or “fun”).

It is important to note that there may be multiple task ratings 350 associated with a given task, and each task indicator 350 may designate a different aspect of the task that is being rated. Further, the task creator may choose to assign their own rating to the task or “crowd source” the rating for the task. Using this approach, each event participant that completes or engages the task will be allowed to provide feedback regarding the nature of the task, using predetermined criteria, with the accumulated results determining the actual value of task rating 350. The task creator could also assign an initial value for a given task rating 350 and then allow the task rating 350 to be adjusted based on event participant feedback.

Random indicator 360 is an event attribute that can be used to describe the a randomization aspect of a given task. For example, a task may be randomized for inclusion in an event. With multiple randomized tasks, the exact nature of an event, and the associated tasks, will take on a more random and unpredictable nature. The randomization may be determined based on almost any imaginable factor, such as location, time, etc. Additionally, the randomization may be based on the event participant's desire and/or profile, including participant's past behavior. For example, the user may request randomization of tasks in an event to enhance their enjoyment of the event. Alternatively, the randomization may be affiliated with the event participant's age, gender, ethnicity, etc. All of these randomization elements may be combined to increase or enhance the participant's level of enjoyment or challenge for the event.

Share indicator 370 is an event attribute that can be used to describe the access permissions for the event. For example, the creator of the event can designate that the event is “private,” “public,” or “group” enabled. If an event is designated as a private event, the event can only be used in activities created by the creator of the event. If the event is designated as a “public” event, then the event may be used in events created by other users as well. Alternatively, there may be a “group” designation associated with share indicator 370, allowing other members of the designated group to include the event in activities that are created by members of the group. The group may be an “invite only” group, or a dynamically created group based on participant profiles, including ratings of a participant by other participant. In this fashion, share indicator 370 provides for maximum flexibility in the use of events in a modular fashion, providing for efficient and effective creation of activities from previously created events.

Task reward or task value 380 may be used by the task creator to assign a reward or value to a task. For example, it may be desirable to motivate the event participants by offering a reward for completion of the various tasks associated with an event. The rewards may be monetary or other forms of remuneration, such as real or virtual “badges,” “titles,” “treasure” or “swag.” Alternatively or concurrently, the event may be worth a certain number of “points” or other units of measure that can be accumulated to keep score for applications such as games. By using a task reward or task value 380 in conjunction with events, the event participants can be motivated to continue with additional tasks. Rewards and values may be based on time to complete an event, or other type of measurement.

Finally, if desired, the event creator may also define and associate one or more event reward or value 390 for completion of an event. This may be useful for motivation or as a way of establishing a series of interconnected events, with one or more events being positioned as “pre-requisites” for subsequent events. Only by completing the events in the pre-determined order will the participant be able to move on to other events in the chain. Alternatively, event reward or value 390 may be utilized as a way to accumulate a “grand total” or other score keeping mechanism by which to judge the performance of multiple event participants as they complete an event. For example, the individual tasks may each have a task value 380 and by adding up the individual results from each task to generate an event value 390, the overall performance of multiple event participants may be evaluated and judges after the event has been completed by all event participants. Similarly, event value 390 may simply be the accumulated time used by the event participant to complete each task in the event. In a game environment, the scores and results of the event may be posted to an event participant's social media profile, indicating their participation in the event and including details such as time or score and prizes or rewards gained by the event participant. This may induce others to join the event or participate in a similar event in the future.

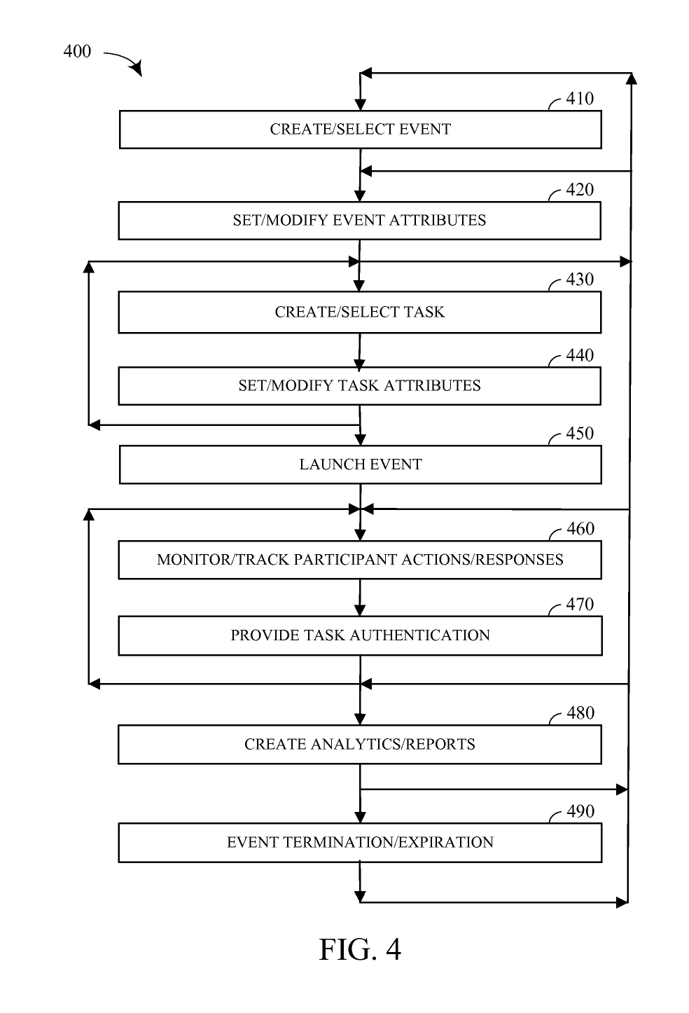

Referring now to FIG. 4, an overall process and method 400 for creating and deploying an event using an event framework in accordance with a preferred embodiment of the present invention is shown. It should be noted that the creation and management of events and tasks can be accomplished using any of tablet 160, workstation 170, laptop 180, and phone 190 of FIG. 1. For convenience, an event creator may decide to use one device over another. As shown in FIG. 4, the first step is to create or modify an event (step 410). If an existing event it to be re-purposed, the existing event may be selected. If no existing event is to be re-purposed, then a new event can be created.

Next, the event attributes or parameters are set or modified (step 420). This includes naming the event and determining the other necessary information for the event. For example, whether the event will be a public event, open to all potential event participants or limited to a certain group of participants, where the participants have been selected based on a given selection basis such as demographics, etc. It should be noted that the events and associated tasks may be stored as records in database 223 of FIG. 2.

Once the event attributes have been finalized, one or more tasks may be added to the event (step 430). It's important to note that a previously used task may be re-purposed by selecting the task from the pool of available tasks. If no previously used task is to be re-purposed, a new task may be created.

After a task has been selected or created, the task attributes will be set or modified (step 440). In this step, the task attributes, as shown in FIG. 3, may be determined. If a task is a re-purposed task, then the existing task attributes may be modified. Otherwise, the desired attributes for a new task will be determined and associated with the new task. The creation and modification of tasks may be repeated as necessary until the desired number and types of tasks have been added to the event.

With all of the relevant tasks created or modified, the event may be launched for access by the intended event participants (step 450). This may include any type of announcement, social media posting, email campaign, traditional advertising, or other means. In any case, the intended participants are notified of the event and they may access the event via the user interface used in conjunction with the event mechanism.

Once the event has been launched, the event participants may begin to complete the tasks associated with the event and the actions and responses of the event participants will be monitored, tracked and recorded (step 460). This step will continue for the duration of the event. This information will be available to the event creator for later analysis in the form of reports, statistics, and analytics (step 480).

At some point, the event will expire or be terminated (step 490). At this point, additional reports and analytics may be generated (step 480) or another event may be created (step 410).

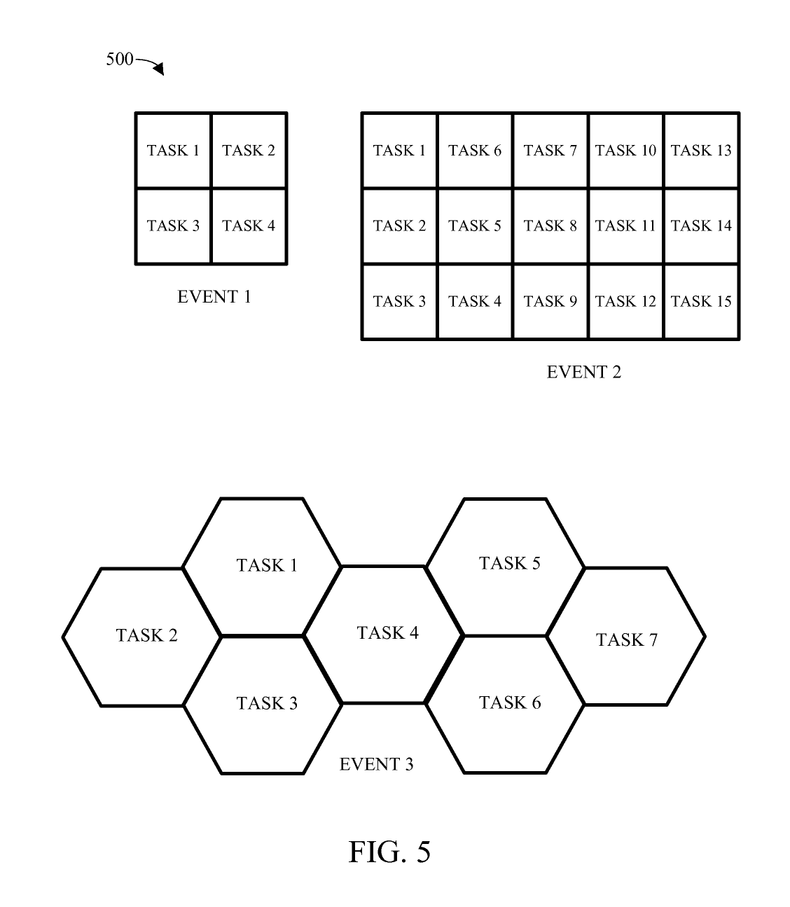

Referring now to FIG. 5, a plurality of tasks for an event application are arranged in various displays 500, with each display 500 providing a visual representation of an event and the tasks associated with each event. As shown in FIG. 5, the tasks can be presented in many different orientations by using icons, such as “task tiles” to represent each task. Event 1 shows a simple square arrangement with four task tiles, representing four tasks in Event 1. Event 2 shows a larger event, with 15 task tiles, arranged in a rectangular format. Event 3 shows another event, with 7 task tiles, where each task is represented by a hexagonal task tile. Three dimensional shapes (e.g., cubes and columns) and many other variations may be deployed, depending on the specific event and the level of complexity for the event.

The task tiles for an event may be represented in many visual variations and include color, shading, and other visual indicia such as animation and graphic designs to stimulate the event participant while completing tasks. In at least one preferred embodiment of the present invention, each task may be sponsored by an individual or entity that wants to advertise or otherwise promote its product and services. As each task is completed and authenticated, the sponsors logo may be highlighted on the appropriate task tile and the reward for completing that task may be a discount coupon or other promotion offered by the sponsor.

Additionally, the visual representation of the event can be modified to provide visual feedback to the event participant, reflecting progress in or completion of the event. As each task is completed and authenticated, the color of the task tile may be modified or the task may be represented by a altering the graphical icon or image on the task tile. For example, as an event participant works on each task, the color of the task tile may initially be red and then changed to yellow once the event participant starts the task, signifying an “in progress” task. Then, once the task is completed and authenticated, the color of the task tile may be changed to green, signifying that the task has been completed. These various graphical cues provide a visual mechanism or feedback indicator to the event participant, motivating the event participant as the tasks are completed.

With the various aspects of event mechanism 227 and associated tasks in mind, the overall process for designing, creating, and executing an event using system 100 of FIG. 1 can be more fully explained and illustrated by several use cases that will highlight the actual application of system 100 to a “real world” scenario.

HOTEL/CASINO APPLICATION. In this scenario, a large multi location hotel/casino is using the event framework of the present invention to keep guests focused on spending their time and money at their hotel/casino family of corporate properties, while encouraging the guests to engage in additional adventures and meet new people. The hotel/casino is also interested in creating marketing attention for their properties while simultaneously attracting more guests to their properties.

The challenge for the hotel/casino is that they traditionally have been competing with each other as well as against the true competition. There are many options in a town like Las Vegas and guests may stay at one property, but spend much of their time and money at competing venues. Using the event framework to drive behavior, the hotel/casino can encourage guests to use the facilities and amenities at company owned properties, thereby “capturing” the guests' time and money.

The key benefits that the hotel/casino can gain from using the event framework and related tools and methods described herein to create one or more customized social networking games (events) are significant and include:
keep customers within their properties at different locations within the same city
focus guest spending at owned properties or affiliates while avoiding competitors
Event framework provides games that allow guests to earn rewards for dining, shopping, gambling, shows, spas, and hotel stays in company properties
by placing tags throughout properties it will encourage guests to create their own games and further drive more guests, effectively providing free advertising
rewards from the event framework ties into existing corporate rewards system
guest can use tags to retrieve rewards at properties
guest may select reward system points or other prizes
mini games can be created within the larger event framework games to encourage desired guest behaviors. This may include answering questions about a show (virtual non location dependent) or encouraging guests to take photos for promotions, etc.

By creating a game (social network event) using the event framework of the present invention, the property owners would be able to create tasks that are not only location dependent such as a specific task at their casino but also tasks with no location dependency such as take a picture with a show girl in costume at any property. Sample tasks include: using a penny, quarter, dollar and $10 slot machine at a casino property.

The property owners could create tiered games that would allow guests to play the first game to access the next game. The first game would be very easy to complete, and would encourage participation by the guests. It would also give guests a chance to learn how the social network event framework games worked, while encouraging them to share the game with their friends. The next game, dependent on completing the first game, would include larger and/or more elaborate prizes such as dinner with a celebrity and more exclusive prizes only available by playing the game.

The initial games would also introduce the concept of cooperative play, by making one or more tasks dependent on working with another guest to complete the task. This would allow the guest to either bring in a friend or find a stranger to help them complete the task. This type of event would be something fun, such as taking a picture of the guest and someone else next to the statue in the lobby. The guests would learn how to authenticate a task for another person and see how cooperative play worked within the game structure.

The game could also be branded with the name and logo of the casino/hotel, making the game more closely integrated in their brand. There would be minimal inclusion of the social network activity framework brand at that point and more emphasis on the game play and making the experience fun for guests.

To win a social network activity framework game the property owner could create different games with different winning criteria. For example, the guest could complete any 3 tasks to win, or accumulate a set number of points (with various numbers of points assigned to each task) to win, or the guest or team of guests with the most points by a certain point in time wins the game (event). In that fashion, the property owner can promote the behavior desired based on setting the criteria for winning the game.

Using this example, the guest would be encouraged to participate in games (events) by scanning tags placed throughout the property. There would be tags placed at the reception area, on the guest check-in paperwork, in each room, and on the receipts from each store within a property. As guests checked into the property they would be encouraged to install the game application on their mobile device through the simple act of scanning one of the tags. If they already have the game application loaded on their mobile device, it would show them what games are available at that location, if they don't have the mobile application installed, it would allow them to install it on their mobile device.

As guests started to play the game, they would be able to include their friends by sending invites through their existing social media channels including emails, posts, blogs, or other simple tasks such as scanning a tag on a friend's phone.\

The guests would find that they were able to complete different tasks by using the different authentication methods built into the game. Introduction games would guide the guest through the different authentication methods. Initially the guests would be able to just say they completed a task for authentication, then move on to other authentication methods including taking a photo of the task, using the geo-location feature of their mobile device as well as scanning tags, and could then move on to including multiple authentications protocols for a task.

As guests continued to play the games, they would be able to use the delayed completion feature where they could complete a task but set it to delayed, to avoid being stalked. The delayed check in event completion option allows the game to delay the authentication and/or the reporting action until the guest has either left the location, until a specific time has passed or the guest returns to “home” where the activities for the entire day are batched or stored up. Since the game allows guests to check in to the major social/location based services, this delayed feature will enhance the guest's privacy.

As guests play the game, the property owner will be able to gather analytics that will provide additional insight into their guests' behavior to better provide the services they want. For example, the information gathered from the guest's game related activities may indicate that the guest enjoys gambling (specifically playing craps), that the guest also likes eating at seafood restaurants, and that the guest prefers to stay in low level suites. The guest could then receive special offers that match their demonstrated patterns as well as receiving “in game advertisements” that are very specifically aligned with their past behavior or that promote additional desired behavior (for example, an upgrade to a more expensive suite if the guest stays three or more nights).

The property owners are also able to look at both aggregated system data as well as individual guest data via the reporting portion of the event framework. This reporting function would allow the properties to optimize and incentivize the desired behavior.

CORPORATE EMPLOYEE APPLICATION. A large Fortune 200 corporation could use the event framework described herein to create a game (event) that will engage new employees during the intake process, with the goal of keeping employees engaged when working on mundane tasks within projects and making ongoing corporate tasks rewarding and fun.

The challenge for many large corporations is that they can seem like boring and uninviting places where employees are often unmotivated to achieve beyond the basic level of performance. With the use of the activity framework in the corporation, this could change from the first day of new employee orientation by using the social networking aspects of the event framework as the catalyst for a new approach. As employees work on various projects, the events created by the event framework would be designed to align with the project management suite to update progress on project tasks, while making the tasks fun and rewarding. The social networking aspect of the event framework would also help improve the image of the corporation in the community through driving the employee community engagement.

The key benefits that the corporation can gain from using the event framework and related tools and methods described herein to create one or more customized social networking games (events) are significant and include:
engage new employees from the beginning and get them engaged in the corporate culture
maintain connections from the hiring group, keeping communications open
make mundane activities in routine projects more fun and rewarding
drive desired employee behavior to advance corporate culture
keep employees engaged in community projects, making the activities more fun and spreading positive messages about the corporate brand
help managers evaluate employee during reviews and provide a roadmap for growth
align employees work with the corporate goals

Large corporations often hire in batches across departments and often bring in the new hires for a corporate orientation. The corporate human relations “(HR”) department could create games (events) for new employees and encourage them to download the event mobile application prior to arriving for their new employee orientation. On the orientation day the employees will be able to scan a tag to start playing the HR game provided by the corporate HR department.

Managers could develop games that will guide employees along a progressive growth path. Developing hexes that are based on demonstrated skills or leadership activities that employees need to demonstrate for performance reviews. Large corporations have established roles and responsibilities as well as expected skills to demonstrate which would be put together in games based on the employees skill level. For entry level employees the manager could outline specific certifications to obtain (Get your PMP certification) as well as skills to demonstrate (Lead a cross functional team) and incorporate the individual tasks into a development plan for that employee.

Corporate goals could be translated into Hexxa games and competitions could be setup for inter-department or cross department completion of specific corporate objectives. Often times the objectives are set in a company but are not visible to the employee on a regular basis. With an appropriate event and tasks, each employee will have the goals and progress at their fingertips.

When coming in for the new employee orientation, the employee would load the HR game onto their mobile device to find that all of the new hires are competing to complete the game, which would consist of accomplishing all the tasks required during corporation orientation. The HR team requires all new hires to complete certain tasks such as read the HR information package, have lunch with a VP in the company, meet 5 people in their department, take 6 mandatory training or orientation classes, getting a laptop, finding their cube, signing in to all the HR systems and taking an online survey. Since all of these items are required and some are required prior to completing others, the HR team has created a game up to have certain tasks be dependent so they are completed first.

Employees would play the game when they started new employee orientation at the corporation and would be able to see who else is in the same group. The employees could also compete with the other new hires to complete the orientation requirements first. The HR department could put incentives in place to encourage the new employees tom complete the tasks, including rewards such as additional time off or other prizes. The new employees would be able to maintain contact with the other new employees even though they would be in different departments and certain tasks may require the new hires to work together to complete the tasks, thereby creating inter-departmental bonds between newly hired employees.

Whenever there are large projects there are almost always certain tasks that are disliked and that is where the project managers would be able to use a game created by the event framework to help drive these mundane tasks to completion by having teams cooperate to complete them while competing against other teams. For example, the development team could work on a section competing with the testers to get their section done, the first team to complete the tasks in their respective sections would win prizes such as additional time off, or other prizes. The teams would be able to see the progress in the event framework and as each task was completed it would automatically update the project plan so the progress is tracked.

Getting employees to engage in community service activities isn't always easy, but corporations enjoy great relationships with the community, greatly improving their image and brand. The VP in charge of community projects could have her team create one or more games (events) associated with the different community projects available and have employees join the games. As the employees play the game taking pictures for verification, the pictures could be used to motivate others to help and to share the good work the corporation was doing in the community.

As employees play games, the management will learn about their employees, and how to better communicate with them. The employee could receive special offers that match their exhibited preferences as well as meeting with other employees through the games that would further improve communications between teams.

The corporation would be able to look at Social network activity framework games both from an aggregated data perspective as well as user data via the reporting portion of activity mechanism 227 of FIG. 2. This reporting would allow the managers to optimize and incentivize the desired behavior as well as use this during their quarterly reviews.

Other features may be included in a preferred embodiment of an event framework as described herein. For example, participant notifications may be configured by event creators or by users via user interface 224 and communication server 225 of FIG. 2. In this fashion, participants are able to determine how other participants are notified (e.g., on a per task basis, per game basis, or for the entire framework basis). Participant may also use existing social media accounts and channels for communicating to their friends and associates that may or may not already be using the mobile applications for the event framework. This may include “posts” and “tweets” for example. By allowing both automated and manual communications from within the event framework, a viral notification loop can be created as more users are brought back to the event framework to participate in one or more games.

Participants can also manually invite other participants to join a game when a new game, task, group or action are created or performed within the event of the event framework. Event creators and participants are also able to set parameters where automated notifications can go out via any and all communications channels established for the participants. Some example parameters may include automated notifications sent at event or game creation, task creation or completion, rating users, rating tasks, rating activity framework, posting pictures, completing tasks, completing activity framework, joining groups, and any other activity framework actions.

Communications channels can include internal messaging, SMS, MMS, email, social media channels such as Facebook®, Twitter®, or any other social channel the user configures within the game framework. The notification can include graphical elements that associate with the communications as appropriate to the channel of communications used. The communications may include links back to one or more of the events created by the event framework and include additional invitation information to influence the actions of the message recipient.

Users may also rate an event created by the activity framework, individual event tasks as well as other participants within the activity framework. The ratings are on a scale based on the event frameworks settings and as determined by the event creator. There can be multiple ratings categories for each ratable item within the activity framework. The ratings provide a social aspect to the event framework within the framework to allow participants to share and determine the categorized ratings for individual items within the game. These ratings can be used to select which items a participants would like to interact with in the event framework. All of these ratings may be provided to the event participants in the way of feedback. The event framework would allow participants the option of using a larger screen normally associated with computers to administer the event framework.

Additionally, an event may provide the opportunity to make “in app” purchases for points, coupons, virtual items and other game related items from within the event framework. Participants may be allowed to trade points with other participants and can use points to obtain virtual items as well as physical items.

An event or game can also be configured to provide an activity layer over real world events by allowing participants to associate a combination of activities, requirements, goals, rewards and communications. This would allow event creators to use the event framework to create events that allow mundane tasks to become more enjoyable and aligned with core human dynamics that further motive action. The event framework would allow events to drive behaviors in the real world enhancing the participants' experiences and further motivating engagement and action of desired behaviors.

In addition, the event framework may provide the ability to incorporate an experience measuring system showing progress and giving users of the activity framework feedback on progress. The measuring system can consist of progress bars, number of items out of a total number of items (x out of y), color codes, numbers, lines or any visual representation of progress.

The event framework also provides the ability to offer multiple long term and short term aims with an event or game. The use of multiple long term and short term aims aligns with a core human need to further stimulate participant engagement. Long term aims could include overall game completion, goal achievements within the game such as completing >50% of game, achieving virtual predefined prizes such as badges or other forms of recognition. Short term aims could include task completion within a game, goal achievements within the game such as completing a dependent task so another task can now be completed, achieving discount codes for real world goods, etc.

Event creators are also provided with a method of rewarding users for effort performed with the event framework. Users could receive points, virtual items, virtual badges, virtual prizes, physical prizes, discounts, social status, elevated rights within the activity framework and other rewards as the event framework is used to create tasks for an event.

Properly designed events will also incorporate a method of providing rapid, frequent and clear feedback when participants are completing the tasks within an event. Participants could receive feedback when tasks are completed, users are rated, social notifications occur, items are rated, activity framework are rated, status changes or any change in condition within the game occurs providing rapid feedback.

The event framework of the present invention also comprises a method of introducing an element of uncertainty to further enhance the engagement of participants. Participants could compete against other participants, cooperate with other participants, and compete against a time limit, all which introduce an element of uncertainty. Participants also have a level of uncertainty introduced with every new event or game, new participant and new task engaged.

The events created using the present invention may also comprise a method of allowing engagement with other people, which is another activity that aligns with core motivators built into humans, driving event participants to see further engagement with other participants within the events of the event framework.

Additionally, at some level, the incorporation of monetization methods through a tiered model incorporating both onetime fees as well as subscription fee structures may be included for certain events. Participants who download and participate in events created by the event framework can participate at many different levels. For example, they may have a free account that allows for public access, an entry level paid account with allows participants to create and play private events or games, a business account that allows businesses to incorporate discounts, incentives and have access to analytic information on their activity framework and tasks, corporate accounts may have the ability to white label event frameworks with full analytics information and agency accounts that allow administration of multiple corporate or business accounts.

Those skilled in the art will recognize that the event framework of the present invention provides an event creator the opportunity to engage participants by using multiple avenues for motivating and reinforcing desired behaviors: visual graphics measuring progress; multiple long and short term aims; rewards for effort; rapid, frequent, clear feedback; an element of uncertainty; other people; and windows of enhanced attention.

In addition to the examples previously given, there are multiple other events that can be created using the event framework and associated tools and methods described herein. For example:
A city could mark all of the landmarks in the city and have people do a museum tour of the city for discounts or prizes. The city could also reward users of public transit if they used it x number of times per set time, or users of libraries or any city property, such as parks, libraries, museums, landmarks, or even businesses;
Associations can use it at trade shows to show that they have attended x number of booths/vendors;
Organizations such as the Boy Scouts can set up merit badge or rank advancement as a game and make the challenge more fun and engaging within their troops and districts;
A wife could set up a private game where the tasks contained the items the husband needed to buy from the store (shopping list), so that the husband gets the ‘right’ things;
Fraternity/sorority can set up a private game for pledge week and have pledges compete;
Companies can set up activity framework where people purchase items on special and compete to be the first to buy x items for a discount or other incentive;
A state could reward positive behaviors of citizens such as carpooling, creating a game with carpooling on it, this could be verified because of the need to have more than one person there and they would use photo & location as authentication and users that carpooled x times per week could be given a prize of tax credits for completing the behavior;
Amusement parks can setup attractions and rides as tasks on a game board and have teams compete to complete all the rides first. This would also allow flow control within the park and enhance usage of less popular attractions;
Companies such as a large retail tool seller can set up a board where people need to use their tools and build projects, first to build x projects wins a new power tool, or discount code, etc. By using the game users are using their social channels to see progress of others and enhance engagement and brand awareness;
Grocery or other retail stores could set up a game where a limited number of items are on sale and participants in the game would compete to get those limited number of discounts and win a very limited number of coupons available, such as the first 50 people to buy 5 boxes of General Mills cereal get a $5 coupon good for anything in the store;
Colleges could create games (events) for each class and the normal class syllabus would make up the game board, then students would be able to engage each other, compete and cooperate on assignments helping to motivate the learning process through game play; and
Project management software could use the activity framework API to create activity framework for tasks within a project and then allow teams to coordinate and compete for completion of the tasks. Placing an activity layer on top of less fun project tasks, allowing automated updating of the management software and all of the advantages of tying in to core human motivators associated with the activity framework. Project managers could set up incentives that team members could compete against each other to earn.

As will be appreciated by one skilled in the art, aspects of system 100 disclosed herein may be embodied as a system, method or computer program product. Accordingly, aspects of system 100 may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of system 100 may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of system 100 may be written in any combination of one or more programming languages, including an object oriented programming language such as Java, Smalltalk, C++ or the like and conventional procedural programming languages, such as the “C” programming language or similar programming languages. The program code may execute entirely on the user's computer as a stand-alone software package, partly on the user's computer and partly on a remote computer or entirely on the remote computer or server. In the latter scenario, the remote computer may be connected to the user's computer through any type of network 120, including a local area network (LAN) or a wide area network (WAN), or the connection may be made to an external computer (for example, through Internet 195 using an Internet Service Provider).

The various preferred embodiments of the present invention are specifically designed to provide a user-configurable platform for implementing a social network activity framework, including facilities for monitoring and tracking user-defined events and occurrences as well as the associated ability to generate message events to send messages, feedback, and reports to a wide variety of users, via multiple communication methodologies. The messages are any form of communication and may include communications such as status reports, interim progress updates, alerts, warnings, surveys, etc.

Aspects of the system are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Additionally, various preferred embodiments of the program product may be configured to: create and modify multiple databases; track, update and store data relative to event tracking and reporting; configure and implement various search and retrieve functions for a plurality of search requests and determinations made by users of the system; track and store information about various services and fees; update and transmit search results to one or more users; and provide one or more user interfaces for accomplishing all of these functions. Various preferred embodiments may also include a plurality of structures that are disclosed herein in singular form, or a single structure disclosed herein as a plurality; those skilled in the art will recognize when this may be effective for some embodiments.

In this fashion, individuals and entities can utilize the program product to design, develop, and implement a wide variety of activity applications for use in a plurality of environments. Similarly, a program product in accordance with one or more preferred embodiments of the present invention can also be configured to perform substantially all of the steps depicted and described in conjunction with the figures herein for implementing a social network activity framework as described herein.

From the foregoing description, it should be appreciated that the system and method for implementing a social network activity framework disclosed herein present significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A system comprising:
at least one CPU;
a memory coupled to the at least one CPU;
a database residing in the memory;
an activity mechanism residing in the memory, the activity mechanism interacting with the database to create at least one event, the at least one event comprising a plurality of tasks, each of the plurality of tasks comprising a plurality of task attributes being selected from a group consisting of: task location; task duration; task authentication; task rating; and task reward;
and wherein the plurality of tasks are performed by a human being at a plurality of pre-determined locations, with at least one of the pre-determined locations being a virtual location that is independent of any physical location, allowing the human being to complete at least one of the plurality of tasks at the virtual location.

2. The system of claim 1 wherein the at least one virtual location comprises at least one of a URL, a page in a book, or a scene in a movie.

3. The system of claim 1 further comprising a visual representation of the at least one event and the plurality of tasks, the visual representation being displayed to a person via a mobile device.

4. The system of claim 1 further comprising a person operating a mobile device, the person providing a plurality of responses to the database via a mobile device user interface, wherein at least one of the plurality of responses is an authentication protocol verifying completion of at least one of the plurality of tasks.

5. The system of claim 1 further comprising:
a plurality of authentication protocols, with at least one of the plurality of authentication protocols being associated with each of the plurality of tasks, the plurality of authentication protocols comprising:
a gentleman's agreement;
an automatically generated location signal;
a photo of a specific place or object; and
a third party verification; and
a plurality of share indicators, with at least one of the plurality of share indicators being associated with each of the plurality of tasks, the plurality of share indicators controlling access to the plurality of tasks, the plurality of share indicators comprising:
a private share indicator;
a group share indicator; and
a public share indicator.

6. The system of claim 1 further comprising:
a plurality of event ratings residing in the memory, wherein at least one of the plurality of event ratings comprises an aggregation of a plurality of individual event participant event ratings;
a plurality of task ratings residing in the memory; wherein at least one of the plurality of task ratings comprises an aggregation of a plurality of individual event participant task ratings; and
a plurality of event participant ratings residing in the memory; wherein at least one of the plurality of event participant ratings comprises an aggregation of a plurality of individual event participant event participant ratings.

7. The system of claim 1 further comprising:
at least one reward associated with completing at least one of the plurality of tasks, the at least one reward being at least one of a physical reward and a virtual reward; and
at least one visual feedback mechanism indicating the successful completion of at least one of the plurality of tasks.

8. The system of claim 1 further comprising an API, the API providing a plurality of updates and notices to at least one social media channel regarding completion of at least one of the plurality of tasks, wherein the providing of the updates and notices by the API is delayed, based on at least one of a temporal constraint and a geographic location.

9. A system comprising:
at least one server, the server comprising at least one memory;
at least one database residing in the at least one memory, the database comprising a plurality of records, wherein the plurality of records comprises:
a plurality of events; and
a plurality of tasks, the plurality of tasks relating to the plurality of events wherein at least a first task from the plurality of tasks must be performed at a virtual location, the virtual location being independent of any physical location;
at least one mobile device being operated by a person, the at least one mobile device providing a user interface for accessing the plurality of tasks associated with the plurality of events, the person performing a plurality of actions in response to the plurality of tasks associated with the plurality of events, the person providing a plurality of responses to the at least one database via the user interface, wherein at least one of the plurality of responses is an authentication protocol verifying completion of at least one of the plurality of tasks; and
an API for providing at least one response to at least one social media channel regarding completion of at least one of the plurality of tasks, wherein the providing of the at least one response by the API is delayed, based on at least one of a temporal constraint and a geographic location.

10. A computer implemented method for implementing events using an event framework, the method comprising the steps of:
configuring at least one event, the event comprising at least one task;
configuring a task location for the at least one task, the task location comprising a user selectable virtual or physical location;
setting a plurality of task attributes for the at least one task, the plurality of task attributes being selected from a group consisting of: task location; task duration;
task authentication; task rating; and task reward;
launching the event to at least one event participant;
tracking at least one actions of the at least one event participant; and
recording at least one response generated by the at least one action of the at least one participant.

11. The method of claim 10 further comprising the steps of:
generating a visual representation of the at least one event and the at least one task; and
displaying the visual representation on a mobile device for viewing by the at least one participant.

12. The method of claim 10 wherein the at least one location comprises at least one of a URL, a page in a book, or a scene in a movie.

13. The method of claim 10 wherein the step of setting a plurality of task attributes for the at least one task comprises at least the step of selecting a random indicator for the at least one task, the random indicator introducing an element of random behavior to the at least one task.

14. The method of claim 10 wherein the step of setting a plurality of task attributes for the at least one task comprises at least the step of selecting a share indicator for the at least one task, the share indicator controlling access to the at least one task.

15. The method of claim 10 wherein the step of configuring at least one task comprises the step of selecting a previously created task from a pool of available tasks, where the availability of the task is controlled by a share indicator, the share indicator being selected from a group comprising:
a private share indicator;
a group share indicator; and
a public share indicator.

16. The method of claim 10 wherein the task rating is generated by aggregating a plurality of individual event participant ratings to create the task rating.

17. The method of claim 10 further comprising the steps of:
providing at least one response to at least one social media channel regarding completion of the at least one task, wherein the providing of the at least one response by the API is delayed, based on at least one of a temporal constraint and a geographic location;
generating a visual representation of the at least one event and the at least one task;
displaying the visual representation on a mobile device for viewing by the at least one participant;
wherein the at least one location comprises at least one of a URL, a page in a book, or a scene in a movie;
wherein the step of setting a plurality of task attributes for the at least one task further comprises the step of selecting a random indicator for the at least one task, the random indicator introducing an element of random behavior to the at least one task;
wherein the step of setting a plurality of task attributes for the at least one task further comprises the step of selecting a share indicator for the at least one task, the share indicator controlling access to the at least one task, the share indicator being selected from a group comprising: a private share indicator; a group share indicator; and a public share indicator; and
wherein the task rating is generated by aggregating a plurality of individual event participant ratings to create the task rating.

18. An article of manufacture comprising software stored on a computer readable storage medium, the software comprising:
an event mechanism that includes a user interface for a user to access at least one database, the at least one database comprising a plurality of records, the plurality of records comprising:
a plurality of records for a plurality of events; and
a plurality of records for a plurality of tasks, the plurality of task relating to the plurality of events; and

19. The article of manufacture of claim 18, the software further comprising an application for the creation and management of events via a mobile device, wherein each of the plurality of tasks for each of the plurality of events comprises a task location attribute, wherein the task location attribute defines at least one virtual location for the completion of at least one of the plurality of tasks and for providing visual feedback to an event participant via the mobile device.

20. The article of manufacture of claim 19, the software further comprising an application that controls the provision of task related feedback for at least one of the plurality of tasks to a social media channel, wherein the providing of the task related feedback by the API is delayed, based on at least one of a temporal constraint and a geographic location.
